(19) United States
(12) Patent Application Publication
(10) Pub. No.: US 2007/0244896 A1
(43) Pub. Date: Oct. 18, 2007

(54) System and method for authenticating remote users

(75) Inventors: Gang Liu, Round Rock, TX (US); Weimin Pan, Austin, TX (US); Peter E. Perschbach, Georgetown, TX (US)

Correspondence Address: BAKER BOTTS, LLP, 910 LOUISIANA, HOUSTON, TX, 77002-4995, US

(73) Assignee: DELL PRODUCTS L.P., Round Rock, TX (US)

(21) Appl. No.: 11/404,723

(22) Filed: Apr. 14, 2006

(51) Int. Cl. G06F 17/30

(52) U.S. Cl. 707/9

(57) ABSTRACT

An Active Directory (AD) is utilized to authenticate a remote user to a server or node by providing an object corresponding to the node. The object include an Access Control Entry (ACE) that is listed within an Access Control List (ACL). The ACE also lists privileges that are designated for each specified user. The AD is then queried by the Remote Access Card of a node to authenticate the username and password of a remote user and to determine the privileges granted to such user.

### TECHNICAL FIELD

The present invention is related to the field of computer systems and more specifically to a system and method for using an Access Control Entry to authenticate a remote user in an information handling system.

### BACKGROUND OF THE INVENTION

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

In certain information handling systems it is desirable to allow a user to access a remotely located system or node. Typically, such a remotely located node includes a Remote Access Card (RAC) which is used to access the remote node via a network or other suitable connection. Prior to allowing a remote user to access a remote node, it is desirable for the identity of the remote user to be authenticated. Typically, an Active Directory (AD) may be used to authenticate to a device such as a Dell Remote Access Controller (DRAC) or an OMSA Open Manage Server Assistant. However, authentication methods typically require that the existing schema within an active directory environment be extended. Extending the schema has significant drawbacks in that extending the schema has a global effect and is not reversible. Because of this, such schema extensions quickly become prohibitively complicated and time consuming. Existing schema-less Active Directory solutions may be provided for authenticating remote users. However, existing solutions require an existing unused user attribute in the existing Active Directory environment and also require that all users have the same privileges for using the remote node. Such limitations greatly limit the utility of existing schema-less solutions for authenticating a remote user.

### SUMMARY OF THE INVENTION

Therefore a need has arisen for a schemaless and flexible system for authenticating remote users accessing the Remote Access Card (RAC) of a node.

The present disclosure utilizes an Active Directory (AD) to provide an object for each remote node. The object specifies access rights and contains a user name and password information for each user having remote access rights. Additionally, the Access Control List includes privileges that are assigned or allowed for each specified user.

In one aspect, the information handling system is provided that includes one or more remote nodes that each include a RAC. The information handling system also includes an AD that is connected with the RAC where the AD includes an object corresponding to the RAC. The object includes an Access Control List (ACL) that in turn includes one or more Access Control Entries (ACE). The ACE lists one or more user data entries and one or more privilege entries for each user. Each of the user data entries is correlated with a particular user who is approved to remotely manage the remote node in accordance with the corresponding privileges. The RAC is configured to communicate with the AD in order to authenticate a particular user and determine the privileges associated with that user.

In another aspect, an AD is provided that is configured for authenticating remote users to a remote node. The AD includes one or more objects that correspond to the RAC where the objects include an ACL and one or more ACEs. The ACE is formed within the ACL and lists one or more user data entries and one or more privileges associated with each user data entry. Each listed user data entry corresponds to a user who is approved to remotely manage the remote node in accordance with the listed privileges.

In yet another aspect, a method for authenticating remote users of a remote node includes configuring a RAC object within an AD. The RAC object includes an ACL with one or more ACEs. The ACEs list one or more user data entries and at least one privilege associated with each user data entry. Each user data entry is associated with a user approved to remotely manage a remote node according to the listed privileges. The method also includes receiving a remote access request at the RAC and submitting an authentication request to the AD. Next the remote access request is compared with the corresponding RAC object and the AD provides the RAC with authentication verification of the remote user as well and the corresponding privileges approved for the remote user.

The present disclosure includes a number of important technical advantages. One important technical advantage is the utilization of an object within an Active Directory and the use of an ACL and an ACE to list user identification information as well as privilege information. The use of an ACE allows for authentication information to be provided that includes privilege information that may be revised, updated and managed by a system administrator. Additional advantages will be evident to those of skill in the art upon review of the specification, figures and claims below.

### BRIEF DESCRIPTION OF THE DRAWINGS

A more complete and thorough understanding of the present embodiments and advantages thereof may be acquired by referring to the following description taken in conjunction with the accompanying drawings, in which like reference numbers indicate like features, and wherein:

FIG. 1 shows a depiction of an information handling system according to the present disclosure that includes a remote node, an Active Directory and a user node;

FIG. 2 is a depiction of an information handling system according to the present disclosure including multiple remote nodes and multiple remote users; and

FIG. 3 shows a flow diagram of a method for authenticating remote users to a remote node using an active directory according to teachings of the present disclosure.

### DETAILED DESCRIPTION OF THE INVENTION

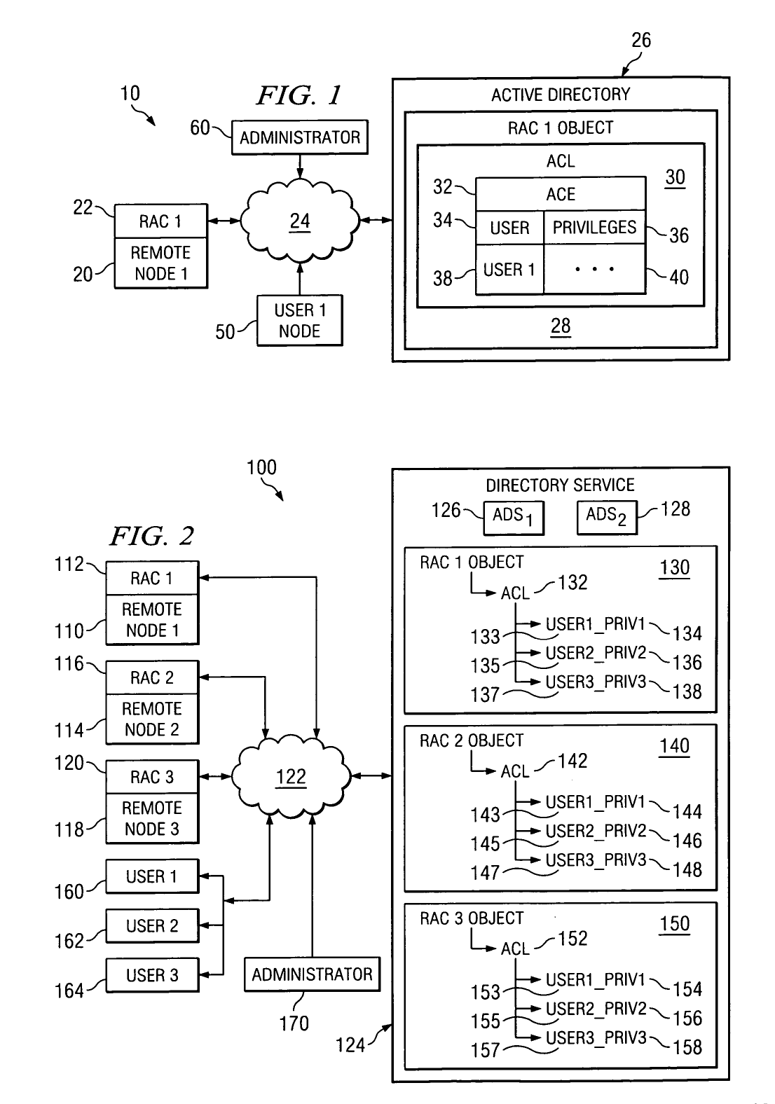

Preferred embodiments of the invention and its advantages are best understood by reference to FIGS. 1-3 wherein like numbers refer to like and corresponding parts and like element names to like and corresponding elements.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

Now referring to FIG. 1, an information handling system, generally depicted at 10, is disclosed. Information handling system 10 includes remote node 20 in communication with an AD 26 via network 24. Remote node 20 may be any server or other device which may incorporate a remote access device such as RAC 22. Remote node 20 includes a RAC 22 associated therewith. RAC 22 allows remote node 20 to send and receive communications via network 24 or directly to and from other devices or systems. In the present embodiment, RAC 22 is a separate hardware device able to interface with remote node 20; in alternate embodiments RAC may comprise any suitable hardware or software, including controlling logic for providing the functions described herein.

Active Directory 26 includes object 28 corresponding to RAC 22. RAC object 28 includes ACL 30 with ACE 32 provided therein. ACL 30 may be, for instance, a Microsoft Access Control List (ACL). ACE 32 lists user data entries 34 and corresponding privileges 36. In the present embodiment, ACE 32 includes user data 38 corresponding to a first user as well as privilege information 40 that corresponds to the privileges granted to the first user with respect to remote node 20.

User node 50 is in communication with network 24 allowing a particular user (in this embodiment, the user is referred to as “first user”) to communicate with remote node 20. In an alternate embodiment, user node 50 may communicate with remote node 20 via a direct connection or through a different network. In the present embodiment, user node 50 communicates with RAC 122 (that controls access to associated with remote node 20). In the event that a user desires to access and/or remotely manage remote node 20, such a user will submit (via user node 50) a suitable request to RAC 22. This request may include a username associate with the user (in this embodiment, first user). RAC 22 then preferably submits a query to AD 26 to authenticate the username and password. Active Directory 26 includes executable instructions for comparing the username and password information that has been submitted by RAC 22 to the corresponding user data in user field 38 which corresponds with the first user.

In the present embodiment, the user data stored within user data field 38 includes a username and password corresponding to the first user. In an alternate embodiment a particular user such as first user may attempt to access a remote node such as remote node 20 through any other suitable access point, computer or other node. After establishing that the submitted username and password matches user data 38, AD 26 authenticates the first user. If the submitted user data 38 does not match any of the user data 34 stored in object 28, AD 26 rejects the remote access request.

After determining the username and password of a remote access request, AD 26 next retrieves privilege information stored in privilege field 40 that corresponds to the privileges that correspond to user data 38. The authentication confirmation as well as the privileges associated with first user are then submitted to RAC 22. RAC 22 then allows first user to access and/or manage remote node 20 according to the privileges listed in object 28.

In one embodiment, the query algorithm within RAC 22 may query AD 26 in the DRAC domain alone. ACL 30 may preferably be encoded to incorporate a Security Descriptor attribute. Further, using Light Direct Access Protocol (LDAP), firmware may query AD 26 to obtain authentication and privilege information from RAC object 28.

In a particular embodiment, RAC 22 includes executable instructions for binding the user/password to the AD server the device belongs to, using LDAP over SSL. Additionally, firmware within RAC 22 queries the RAC object 28 using its DN (distinguish name) to obtain the attribute of a Security Descriptor, which may comprise a binary blob. The firmware of RAC 22 may then decode the ACL 32 encoded in the Security Descriptor, using, for example, Security Descriptor Definition Language (SDDL). Next the RAC may preferably search the user data of the user in ACL 30 to determine the privileges afforded to the user.

In the present embodiment, privileges 36 may include any suitable privileges which may be managed by RAC 22. In a particular embodiment, privileges 36 may include one or more of the following: a login privilege, a virtual media privilege, a console redirect privilege, a user configuration privilege, a card configuration privilege, a power management privilege, a clear log privilege, and a debug privilege.

In the present embodiment, administrator 60 is in communication with active directly 26 via network 24. In alternate embodiments, administrator 60 may be in communication with Active Directory 26 through a direct connection or through an alternative network. In some embodiments (such as shown in FIG. 2 below). AD 26 may be included within a larger system such as a directory service or another suitable system for maintaining AD 26 and making AD 26 available to devices such as remote node 20. As discussed in below, in alternate embodiments AD 26 may include multiple RAC objects, each corresponding to a different remote node. Additionally, each RAC object may include user data 34 and privilege data 36 for multiple users.

Administrator 60 preferably may access object 28 to manage the information contained within ACE 32. In particular, administrator may add or remove users to ACE 32 and may also add, remove or revise privileges 40 associated with each particular user. In a particular embodiment administrator 60 may add additional ACEs or update ACE 32 using the standard tool in AD 26.

Now referring to FIG. 2, an information handling system generally depicted at 100 includes remote nodes 110, 114 and 118 in communication with directory service 124 via network 122. Additionally, users 160, 162 and 164 are in communication with network 122 and able to access servers 110, 114 and 118 via their respective RACs 112, 116 and 120. Additionally, administrator 170 is in communication with network 122 and is operable to access directory service 124 and RACs 110, 114 and 118.

In the present embodiment, directory service 124 includes first AD service 126 and second AD service 128. Both Active Directory services 126 and 128 may access any of RAC objects 130, 140 and 150. First RAC object 130 corresponds to first remote node 110, second RAC object 140 corresponds with second remote node 144, and third RAC object 150 corresponds a third remote node 118.

First RAC object 130 includes Access Control List 132. Access Control List 132 includes first user data 133 and corresponding first privilege data 134, second user data 135 and second privilege data 136, and third user data 137 and third privilege data 138. Second RAC object 140 includes Access Control List 142 listing first user data 143, second user data 145 and third user date 147 as well as corresponding privilege data 144, 146 and 148. Similarly, third RAC object 150 includes Access Control List 152, including first user data 153, second user data 155, and third user data 157 as well as corresponding privilege data 154, 156 and 158.

Each remote node 110, 114 and 118 includes a corresponding Remote Access Card 112, 116 and 120. In operation, as a user requests access to remotely manage one of remote nodes 110, 114 and 18, user will submit a user name and password to the corresponding RAC 112, 116 and 120. For example, second user 162 may submit its username and password to third remote node 118 and in particular, to third RAC 120. Third RAC 120 will then submit a request to directory service 124 (either through first Active Directory service 126 or through second Active Directory service 128) to authenticate or validate the user name and password of second user 162. Directory service 124 then accesses third RAC object 150 and compares the submitted username and password to the information stored therein, in particular, with second user data 155. If the submitted username and password from second user 162 matches the username and password stored within second user data field 155, then the directory service determines that second user 162 is allowed to remotely manage third remote node 118 accordingly to the privileges 156. Directory service 124 also retrieves second privilege information 156 that corresponds to the privileges that have been granted to second user 162 in remotely managing third remote node 118. Directory service 124 may then preferably submit the privilege data 156 to third remote node 118 via third RAC 120 with a message indicating that second user 162 has been authenticated. In the event that the submitted username and password do not match with any of the user data within object 150, directory service 124 may then send a message to third RAC 120 that access to second user 162 is denied.

In a similar fashion, any of users 160, 162 and 164 may request access to remote nodes 110, 114 and 118 and RACs 112, 116 and 120. In turn, RACs 112, 116 and 120 may then request authorization and verification as well as privilege information from directory service 124.

In the present embodiment, three remote nodes 110, 114 and 118 are shown. In alternate embodiments, more or fewer remote nodes may be used in accordance with the teachings of the present disclosure. Additionally, the present embodiments show three users 160, 162 and 164 able to gain access to remote nodes 110, 114 and 118. In alternate embodiments, more or fewer remote users may access remote nodes 110, 114 and 118. Additionally, users 160, 162 and 164 may access network 122 through one or more different nodes (not expressly shown in FIG. 2) such that, for instance, first user 160 may access a remote node from more than one different remote nodes.

In the present embodiment, administrator 170 may access directory service 124 and may revise objects 130, 140 or 150. Administrator 170 may add or remove users within a particular object or may revise, add or remove privileges for a particular user. Additionally, it should be understood that any particular user may be authorized to access one remote node but may not be authorized to access all of the remote nodes. Additionally, the privileges corresponding to a user for one particular remote node may not be the same as the privileges for that user for a different remote node. In this manner, the present disclosure allows for flexibility in managing the privileges that a remote user may have with respect to one or more remote nodes.

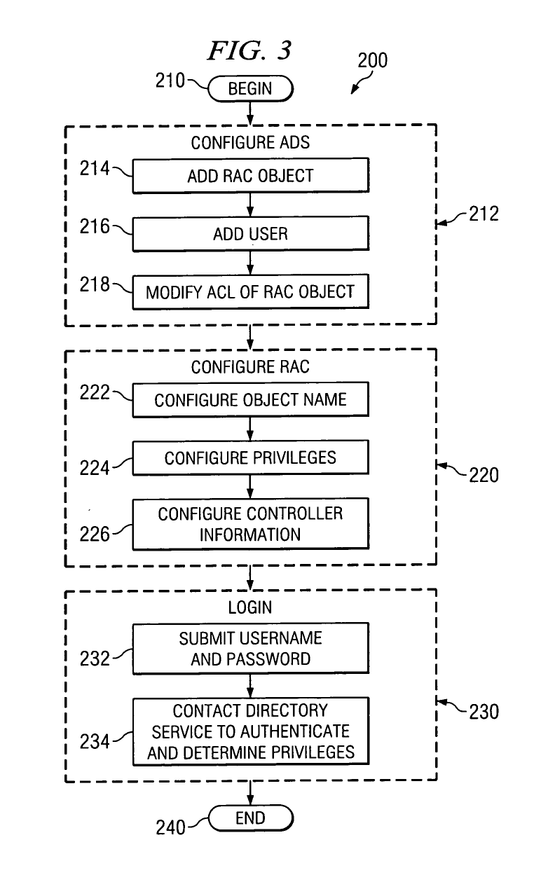

Now referring to FIG. 3, a method according to the present disclosure is shown. The method, indicated generally at 200, begins 210 by first configuring the Active Directory service 212. This step generally includes adding a RAC object 214 that corresponds to a particular RAC associated with a remote node. Within the newly added RAC object, one or more users are added 216 and the Access Control List may be modified 218 to reflect the added user information.

The next general step is the configuration of the RAC element (such as RAC 22 shown in FIG. 1) 220. This portion of the method begins with configuring an object name 222 such that the particular RAC can request authentication or include the proper object name with authentication requests. The next step is configuring privileges 224. This step may include mapping the available privileges associated with a particular RAC to object formed within the AD. The method then includes configuring controller information 226. This step may include the configuration of network settings.

Next, during operation the method includes logging in a remote user to a remote node 230. This includes submitting a user name, password from a remote user 232 to a RAC. The username and password are received at the RAC of the requested remote node, the RAC contacts the directory service and request that user be authenticated and determine the privileges of the particular user 234. The method ends at step 240.

Notably, the present disclosure does not require schema extensions but still allows different users to have different privileges on different devices. Additionally, there is no prerequisite for implementing the present disclosure, i.e., it does not require an unused user attribute in the existing schema. Also, the present disclosure may be effectively implemented using standard Active Directory tools.

Although the disclosed embodiments have been described in detail, it should be understood that various changes, substitutions and alterations can be made to the embodiments without departing from their spirit and scope.

What is claimed is:

1. An information handling system comprising:
at least one remote node having a Remote Access Card (RAC) associated therewith;
an Active Directory in communication with the RAC, the Active Directory having an object corresponding to the RAC, the object comprising an Access Control List (ACL);
the ACL including at least one Access Control Entry (ACE), the ACE listing at least one user data and at least one privilege associated with each user data, each listed user data associated with a user approved to remotely manage the at least one remote node in accordance with the at least one corresponding privilege; and
the RAC configured to communicate with the Active Directory to authenticate a particular user and determine any privileges associated with the particular user.

2. The system according to claim 1 further comprising a user node in communication with the Active Directory operable to allow a user to request access to the RAC.

3. The system according to claim 1 wherein the RAC is configured to communicate with the Active Directory using a Light Directory Access Protocol (LDAP).

4. The system according to claim 1 further comprising:
a plurality of remote nodes each having an associated RAC in communication with the Active Directory; and
the Active Directory having an object corresponding to each remote node, each object listing at least one user data and at least one privilege associated with each user.

5. The system according to claim 1 further comprising an administrator node in communication with the Active Directory, the administrator node operable to manage the ACE.

6. The system according to claim 5 wherein the administrator node is operable to add at least one user data and corresponding privilege within the at least one ACE.

7. The system according to claim 5 wherein the administrator node is operable to revise the privilege corresponding to a particular user data.

8. The system according to claim 1 wherein the at least one privilege associated with the at least one user comprises at least one privilege selected from the group consisting of: a login privilege, a virtual media privilege, a console redirect privilege, a user configuration privilege, a card configuration privilege, a power management privilege, a clear log privilege, and a debug privilege.

9. The system according to claim 1 further comprising a directory service in communication with the RAC, the Active Directory incorporated within the directory service.

10. The system according to claim 1 wherein the user data comprises a username and password associate with a corresponding user.

11. An active director configured for authenticating remote users of a remote node comprising:
at least one object corresponding to a Remote Access Card, the object comprising an Access Control List (ACL); and
at least one Access Control Entry (ACE) associated with the ACL, the ACE listing at least one user data and at least one privilege associated with each user data, each listed user data corresponding to a user approved to remotely manage the at least one remote node in accordance with the at least one corresponding privilege.

12. The Active Directory according to claim 11 comprising the Active Directory configured to send and receive communications using a Light Directory Access Protocol (LDAP).

13. The Active Directory according to claim 11 further comprising a plurality of objects each corresponding to a particular remote nodes, each object listing at least one user data and at least one privilege associated with each user data.

14. The Active Directory according to claim 11 where in the at least one is selected from the group consisting of a login privilege, a virtual media privilege, a console redirect privilege, a user configuration privilege, a card configuration privilege, a power management privilege, a clear log privilege, and a debug privilege.

15. The Active Directory according to claim 11 wherein each user data comprises a username and password associated with a corresponding user.

16. The Active Directory according to claim 11 wherein the Active Directory is configured to communicate with at least one Remote Access Card and authenticate user requests to access the Remote Access Card based upon the user data stored in the ACE.

17. A method for authenticating remote users of a remote node comprising:
configuring a RAC object within an Active Directory, the RAC object having an Access Control List (ACL), the ACL having an Access Control Entry (ACE) formed therein, the ACE listing at least one user data and at least one privilege associated with each user data, each listed user data associated with a user approved to remotely manage the at least one remote node;
receiving a remote access request at the RAC;
requesting a remote user authentication from the Active Directory;
comparing the remote access request with the corresponding RAC object; and
providing the RAC with authentication verification and one or more privileges approved for the remote user.

18. The method according to claim 17 wherein the at least one privilege comprises at least one privilege selected from the group consisting of a login privilege, a virtual media privilege, a console redirect privilege, a user configuration privilege, a card configuration privilege, a power management privilege, a clear log privilege, and a debug privilege.

19. The method according to claim 17 wherein the authentication request comprises a request a request made via a communication utilizing Light Directory Access Protocol (LDAP).

20. The method according to claim 17 further comprising revising the RAC object to update the at least one user data.
